(19) United States
(12) Patent Application Publication
(10) Pub. No.: US 2019/0213528 A1
(43) Pub. Date: Jul. 11, 2019

(54) DIGITAL ASSISTANT TASK MANAGEMENT

(71) Applicant: Microsoft Technology Licensing, LLC, Redmond, WA (US)

(72) Inventors: Rahul GUPTA, Hyderabad (IN); Manish KANSAL, Hyderabad (IN)

(73) Assignee: Microsoft Technology Licensing, LLC, Redmond, WA (US)

(21) Appl. No.: 15/866,770

(22) Filed: Jan. 10, 2018

(51) Int. Cl. G06Q 10/06; G06F 3/0484; H04W 4/12

(52) U.S. Cl. CPC G06Q 10/063118; G06Q 10/063114; H04W 4/12; G06F 3/04842; G06Q 10/063112

(57) ABSTRACT

Various systems and methods for managing impersonated tasks. In an example, the system includes a processor and storage. The processor may cause the processor to identify, in response to input from an input-user, a user generated impersonated task (UGIT) and a task-user from a people graph. The instructions may cause the processor to send the UGIT to a data store for a task-user device in response to a verified communication permission status. The instructions may cause the processor to monitor for an indicator from the task-user device, wherein the indicator corresponds to completion of the UGIT. The processor may also modify a data object corresponding to the UGIT based on the indicator from the task-user device to reflect a completion status and a set of users related to the UGIT to be notified of the completion status. The processor may transmit a digital notification to the set of users.

### BACKGROUND

User communication with other users to discuss, plan, and assign digitally recorded tasks can take many forms including calls, messages, chats, or in person requests for another user to individually create or complete a task. Tasks may include digital objectives such as completing coding for a particular function in a larger piece of software or non-digital directives such as the coordination of a caterer for a large party, among others. Each user independently creating and managing digital tasks can include a redundant use of processor functions and display energy as well as individual user effort.

### SUMMARY

The following presents a simplified summary in order to provide a basic understanding of some aspects described herein. This summary is not an extensive overview of the claimed subject matter. This summary is not intended to identify key or critical elements of the claimed subject matter nor delineate the scope of the claimed subject matter. This summary's sole purpose is to present some concepts of the claimed subject matter in a simplified form as a prelude to the more detailed description that is presented later.

In an example, a system for managing impersonated tasks through a shared device can include a processor and a storage with instructions for execution by the processor. In an example, the system includes a processor and storage. The instructions may cause the processor to identify, in response to input from an input-user, a user generated impersonated task (UGIT) and a task-user from a people graph. The instructions may cause the processor to send the UGIT to a data store for a task-user device in response to a verified communication permission status. The instructions may cause the processor to monitor for an indicator from the task-user device, wherein the indicator corresponds to completion of the UGIT. The processor may also modify a data object corresponding to the UGIT based on the indicator from the task-user device to reflect a completion status and a set of users related to the UGIT to be notified of the completion status. The processor may transmit a digital notification to the set of users.

In an example, a method for managing impersonated tasks can include creating a user generate impersonated task (UGIT) based on an input received through an interaction model of a shared device. The method may include graphically presenting, via a display, an identified task-user and the UGIT, where the task-user is selected from a people graph. The method may also include verifying a communication permission status between a user who generated the UGIT and the task-user from a consent service storage. The method may further invoke a task service to pass the UGIT to a data store of the task-user in response to a verified communication permission status identified at the consent service storage. In an example, the method may also graphically present, via the display, an impersonated task status indicated by the UGIT where the impersonated task status comprises a task-user name and a task completion marker.

In an example, a computer-readable storage device that stores instructions can, in response to an execution by a processor, cause the processor to identify, in response to input from an input-user, a user generated impersonated task (UGIT) and a task-user from a people graph. The instructions may cause the processor to send the UGIT to a data store for a task-user device in response to a verified communication permission status. The instructions may cause the processor to monitor for an indicator from the task-user device, wherein the indicator corresponds to completion of the UGIT. The processor may also modify a data object corresponding to the UGIT based on the indicator from the task-user device to reflect a completion status and a set of users related to the UGIT to be notified of the completion status. The processor may transmit a digital notification to the set of users.

### BRIEF DESCRIPTION OF THE DRAWINGS

The following detailed description may be better understood by referencing the accompanying drawings, which contain specific examples of numerous features of the disclosed subject matter.

FIG. 1 is a schematic of an example system for executing techniques for implementing impersonated tasks;

FIG. 2 is a schematic of an example user preference learning and data tasks technique;

FIG. 3 is a schematic of an example impersonated tasks runtime technique; and

FIG. 4 is a process flow diagram of an example process for managing impersonated tasks in a runtime technique;

FIG. 5 is a block diagram of an example of a computing system for managing impersonated tasks;

FIG. 6 is a process flow diagram of an example process for implementing impersonated tasks;

FIG. 7 is block diagram of an example computer-readable storage device for managing impersonated tasks;

FIG. 8 is block diagram of an example shared device interaction interface for impersonated tasks.

FIG. 9 is block diagram of an example schematic representing a collection of tasks in a task review collection;

FIG. 10 is block diagram of an example client server system architecture for impersonated tasks and a shared device to operate within; and

FIG. 11 is block diagram of an example schematic representing a framework for vocally received impersonated tasks; and

FIG. 12 is block diagram of an example schematic representing a digital assistant management system; and

FIG. 13 is block diagram of an example schematic representing an integration of user-based scheduled messages and impersonated tasks.

### DETAILED DESCRIPTION

As an initial comment, the below description may include examples that are merely one representation of many possible implementations and the below examples should not be seen as limiting when interchangeable hardware, platforms, software, or architectures may perform the same or similar functions. For example, the references to shared devices hosting digital assistants may be housed within computer hardware of many shapes, sizes, user interaction models, and communication types. For example, the hardware may be a full personal computer, mobile device, tablet, speaker system, augmented reality (AR) system, or virtual reality system (VR).

Task creation for digital assistants is disclosed herein, as well as an impersonated task technique for storing and managing the information generated by the user. As used herein, the term “impersonated tasks” refers to how tasks created by one person can be shared, assigned, or delegated to a pool of users resolved from a people graph. Further, in some examples, the impersonated tasks can indicate a set of users who can mark the task as complete, through their own interface or shared device, on behalf of completion of the overall task.

References to a single task may also include teaches applicable to the use of group tasks and group task management. As used herein, a group task may be a task where there are multiple people listed for a task. The use of group tasks may be done for a number of scenarios. For example, one type of group may be a ‘closed group.’ As used herein, a closed group may refer to a typically smaller group like a home or family, where each of the members is in a similar physical location or is related genealogically. The use of the disclosed techniques in a family situation could include using a shared device with speakers and microphones to communicate instructions to the shared device. The shared device recording a user's device may record a first user voice, recognizes the first user voice as belonging to the first user, and then perform the instructions based on the permissions associated with the first user. The identification of a speaker may be based on proximity of familiar devices, through identification through comparison of voice to a voice signature, and other similar identification means. The speaker of the shared device may be able to project and emit the audio announcing the tasks of an identified user to an authorized user. One example of a closed group could be a family with two parents and two children. In this example, the parents may have permissions associated with their user profiles in the shared device that allow them to assign or delegate tasks they create to the children for completion. The concepts of task delegation and completion are further discussed below.

A second type of group may be a work environment. For example, the users may be associated with an organizational structure of an office or workplace. In these structures, the permissions and roles may also be encoded in the permissions of the users of the shared device. For example, a manager may be able to delegate tasks to members of the manager's team, while the members of the team may not be able to delegate tasks to other users or the manager without an approval by the manager.

As used herein, the idea of the task may manifest itself in many different ways. For example, the task may be displayed as plain text. The task may be emitted audio from a speaker of a shared device. The task may be simply a listing of a single objective, e.g. “complete report” or “buy eggs.” Other examples of tasks can include addition details to augment the task. The tasks may be augmented based on follow up questions or with additional details provided by results from a search engine. For example, if a task included “buy whey protein” the shared device could parse the language, perform a search of the words in the task and attach specific queries for a task creator to answer, or automatically populate information based on a user preference or history. In the example of “buy whey protein” this could include either a listing of the nearest locations to make the purchase, a query for a specific brand, a presumption of a specific brand based on previous purchasing habits, a suggestion for a specific product based on previous consumption and query patterns, and similar augmenting information points.

The figures show some examples of the platform, method, device, system, and computer-readable storage medium for performing the example method described above and variations of the above method. The shared devices disclosed herein may host digital assistant systems that include the task creation and management techniques discussed. Further, servers may also host the task management techniques discussed. The discussed techniques, devices, and systems may include the creation of tasks for a personal assistant while providing a technique to the user for creating impersonated tasks. The creation of digital tasks includes creation of impersonated tasks that may be performed by a group of people or a subset of a group or a number of individuals in the group. The impersonated task techniques in the present disclosure have the effect of avoiding overuse of the networking resources of a shared device such as a network card or wireless transmitter. In part, this is because a shared device hosting a contained consent service storage may not need to perform requests to remote devices whenever a permission is requested, instead keeping the request local. This internal hosting of permissions data may also reduce hardware redundancies where instead of each user having their own hardware device for assigning tasks, a number of users may use the single shared device to manage the disclosed impersonated tasks. For example, a user may create their own individual task and then again coordinate amongst a set of users using call, message, and chat feature to identify who has completed the task. The disclosed impersonated tasks technique handles creation, coordination and tracking progress on shared and delegated tasks with other users in a group with which the user is collaborating.

An important aspect to keep in mind is the privacy of user data and the consent of the user in sharing their data, tasks, information with others as well as consenting to the receiving of data, tasks, and information from approved sources. For that reason, this disclosure ensures the privacy and wishes of the user are respected by managing permissions and consent of a user to exchange of information and access to information through a consent service storage. As further discussed below, the consent service storage may be stored locally on a shared device or may be remotely held data that is controlled or accessed by the shared device. The consent service storage securely holds information to ensure that each user of the shared device takes an affirmative action before any data is collected or shared. This is the preferred method whenever practical in a patent application. The settings of the shared device may also be set so that users are automatically asked to opt-in but have an option at any time to take an affirmative action to prevent the collection of data before that data is collected.

The impersonated task technique disclosed can be paired with existing digital assistants to allow users to create tasks for their schedule, and the digital assistant displays the task at a predetermined time or location. These digital assistants may be associated with the shared device and may project audio from a speaker in the shared device. The digital assistant may also take input in the form of recorded audio, typed word, mouse click, gestures, eye glances, and other types of user input. Digital assistants may provide multiple coordination and task tools to mark, comment, and otherwise tag tasks with user notes such as reminders, levels of urgency, groups to perform these tasks, To-Dos, task completion orders, and the like. However, through impersonated tasks, digital assistants on a shared device or a user device allow a user to create a task for use by the user as well as others. In one example case discussed herein, a shared digital assistant such as an in-home digital assistant may have one user create tasks for other users also sharing the in-home digital assistant. For example, a user, such as a parent, may create a task for a second user, such as a child, that he can receive a notification for and complete remotely or on site with the digital assistant.

The disclosed shared tasks can refer to tasks created by a user for multiple users and where any one of those users can complete the task. For example, a parent user may be in proximity to a shared digital assistant, such as a voice controlled and shared speaker device, and vocalize a request for the digital assistant to create a reminder for watering plants. This reminder may be assigned to all users in the family, for example, child users, spouse users, or other family members or housemates. The created reminder may then trigger on the personal devices of each of the members in the group to which this task is assigned. Once any one of the members in the group completes the task, the task may be marked as complete for everyone in the group. Tasks that are delegated rather than shared can be tasks created by a user for a second user where in response to the second user completing the task, both the first user who did the assigning and the second user who completed the task are notified of the tasks completion.

The creation and management of these tasks may be accomplished through coordination between the digital assistants sharing tasks as well as a user confirming identities of other users from which the user exchange tasks, assignments, and completion notifications. As used herein, the notification may be a message, a push notification, an email, a social media alert, a haptic feedback, and announcement by the shared device, a displayed icon, displayed text, a status reminder associated with a user account, and other suitable means of notification of various status or completion conditions. Further, as used herein, the trust circle may be built from multiple sources including multiple users who are authenticated to a shared device, users who are contacted more frequently, and the like.

The term “logic” encompasses any functionality for performing a task. The operations illustrated in the flowcharts corresponds to logic for performing that operation. An operation can be performed using software, hardware, firmware, physical electronic circuits, and the like, or any combinations thereof.

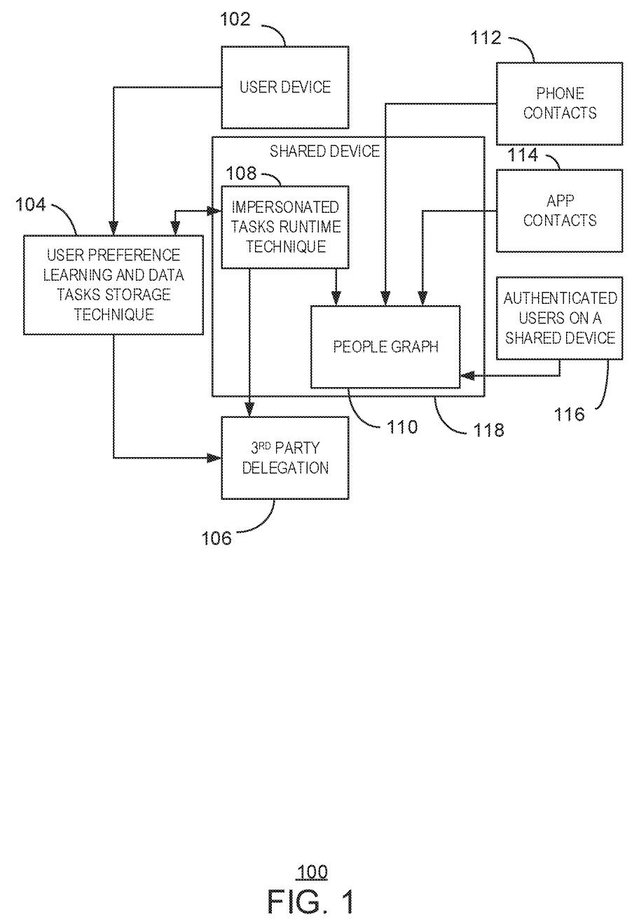

FIG. 1 is a schematic of an example architecture for executing techniques for implementing impersonated tasks. The line arrows in the figure are intended to show a general flow of information and may include either a push or a pull of data from either block shown.

The architecture 100 shows a user device 102 that can be interacted with by a user. The device may receive input indicating a user manipulation the user device 102 to communicate with other user devices. In an example, a device may receive an input for a user manipulating a user device 102 in order to attempt to schedule a task. The user device 102 may communicate this information to a user preference learning and data tasks storage technique (UPLDTST) 104. The UPLDTST 104 may be a memory, storage, or server and may be local or remote from the user device 102 being held by the user 102. The movement of the storage and processing of the task creation and management information from the user device 102 to an external location may reduce the processing load on the user device 102 and thereby improve its functioning as a computer.

The UPLDTST 104 may communicate with third party delegation 106 which may include services, applications, and other techniques made by third parties. The communications from the UPLDTST 104 for the third-party delegation includes indicating for the user the UPLDTST 104 is assigned to, the task being done by third party delegation 106 has been triggered or completed. As used herein, third party delegation 106 relates to applications, services, hardware, or techniques that are created by third parties that can be used to complete tasks a user may request. For example, if a user has an online shopping task, the third-party delegation 106 may be to an online shopping application or service. In another example, the user may request a ride from a taxi or ride-sharing application at a certain time, where the third-party delegation 106 would include passing relevant information to a third-party ride-sharing application at the assigned time.

An impersonated tasks runtime technique (ITRT) 108 may also communicate through third party delegation 106. The ITRT 108 may manage centrally the creation and management of tasks for each user. To manage, create, and mark completed multiple tasks, the ITRT 108 may communicate with a UPLDTST 104 associated with each user in order manage the status of tasks, indicate permissions of a user to view or create tasks, and provide information to each UPLDTST 104 about specific tasks at the UPLDTST 104. The ITRT 108 may also communicate with a people graph 110. While a third party may be delegated to, other types of delegated tasks may be delegated to machines, robots, or otherwise mechanized, digital, or automated non-human entities. In an example, an instruction may be given to a household room cleaner to vacuum at a certain time where the shared device manages the instructions for these automated device settings. In another example, a home temperature managing device may be instructed by the shared device to raise or lower the temperature as instructed by the shared device. As the shared device and the personal assistant may be interacting with automated devices and system, the permissions managed by the shared device and personal assistant may also include permissions and access credentials for theses automated devices and systems.

The people graph 110 may pull application contacts 114 from a device where a person assistant is operating and from lists of authenticated users on a shared device 116, or other predetermined groups. The people graph 110 may represent a stored collection of patterns and relationships about users, the devices they use, the permissions they give each other, and the connections each person may have authorized. The information at the people graph 110 may be collected from other devices, services, and databases including a listing of phone contacts 112, app contacts 114, and authenticated user information 116 on a shared device 118. While the information from the people graph is shown as being collected from phone contacts 112, app contacts 114, and authenticated user information 116, any number of inputs may be used including contacts stored from email accounts, social media accounts, or imported in a mass contact storage file.

FIG. 1 shows one example of a shared device 118 configuration that includes the impersonated tasks runtime technique 108 as well as the people graph 110. The organization of these elements within the shared device is not intended to be limiting as other digital logic organization within and outside of the hardware is also contemplated. For example, the people graph 110 or a copy of the people graph may be stored off site from the shared device rather than locally within a physical hardware that the user interacts with and shares with other users. In another example, the presence of both an example user device 102 and a shared device 118 may indicate that these two device types are separate hardware from one another and that a user may access and manage the above information from multiple endpoints. In an example, the hardware for the shared device 118 may not be a smartphone but a tabletop or mounted computing device with a speaker and a microphone to record user speech. In an example, the shared device 118 may include a digital display user interface with a touch screen or microphone. In an example, the shared device 118 may be a display through virtual reality, augmented reality or another mixed reality where input from a user is provided through voice, motion tracking, touch, or pressing and toggling of buttons on the shared device.

Users of the shared device 118 may wish to access, view, and manage information about their particular people graph or update permissions. The shared device allows user modification of a people graph to add or remove their contacts of their choosing through a touch display, verified voice command, or remotely through an authenticated login. While the people graph may be held locally in the shared device 118, it may also be held and managed remotely in an encrypted storage so that the user who corresponds to the people graph may access the data of the people graph and modify it to suit their preferences.

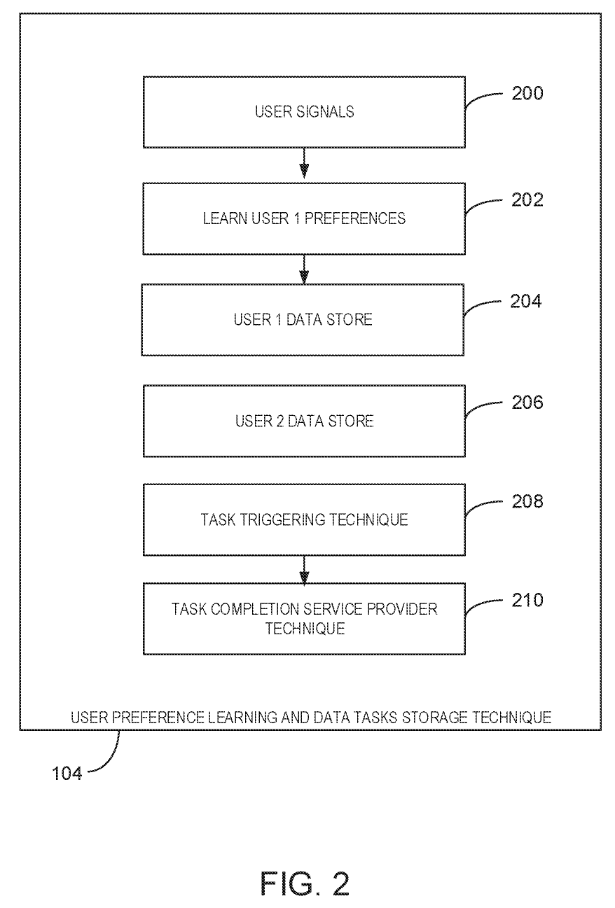

FIG. 2 is a schematic of an example user preference learning and data tasks storage technique (UPLDTST) 104. Like numbered items are as described with respect to FIG. 1.

The UPLDTST 104 includes a number of operations and data storage elements. The UPLDTST 104 may track and record user signals 200 that are received from a user device. The user signals 200 may correspond to instructions and preferences. These preferences may be stored and recalled in the UPLDTST 104 through a storage or memory as learn user 1 preferences 202 stored in a user 1 data store 204. One example of a data store, such as the user 1 data store 204, is a personal data platform that may store user identifying information, messaging information, picture information, or preference and setting information. As disclosed herein, tasks added at the shared device may be added to a user 1 data store 204 based on information from the people graph rather than through other means of task transmittance. The storage of tasks would last at least until marked complete or expired and may also be stored in an archival manner. Archived tasks may be tasks that have been completed or past a certain date of relevance, but still stored and linked to the shared device and a specific user data store for reference or pattern purposes. The tasks that may be stored in the user 1 data store 204 may also include a mix of task types, for example, both personal tasks set by a user on a user device 102 as well as impersonated tasks created for user 1 either on a shared device, a first user using their user device as well as a second user using their device. The UPLDTST 104 may also include digital logic with access to a user 2 data store 206 if multiple users are present and grant the UPLDTST 104 permission to access the additional data store.

The UPLDTST 104 may also include a task triggering technique 208 to maintain a status for a use of a task that is due to be completed. In an example, if a task were scheduled for a certain time, the task triggering technique 208 manages the activation of a display of the task or communicating with third party applications through third party delegation. The status of a task being triggered may be maintained and stored for a user to access in the UPLDTST 104. After a task has been triggered by the task triggering technique 208, the task completion service provider technique 210, may process and store a notification that a task has been completed. The task completion service provider technique 210 may initiate for a user device an action to indicate to a user that the task is completed. In an example, an action may be the removal of the task from a display or an animation or mark associated with the task indicating the completion of the task.

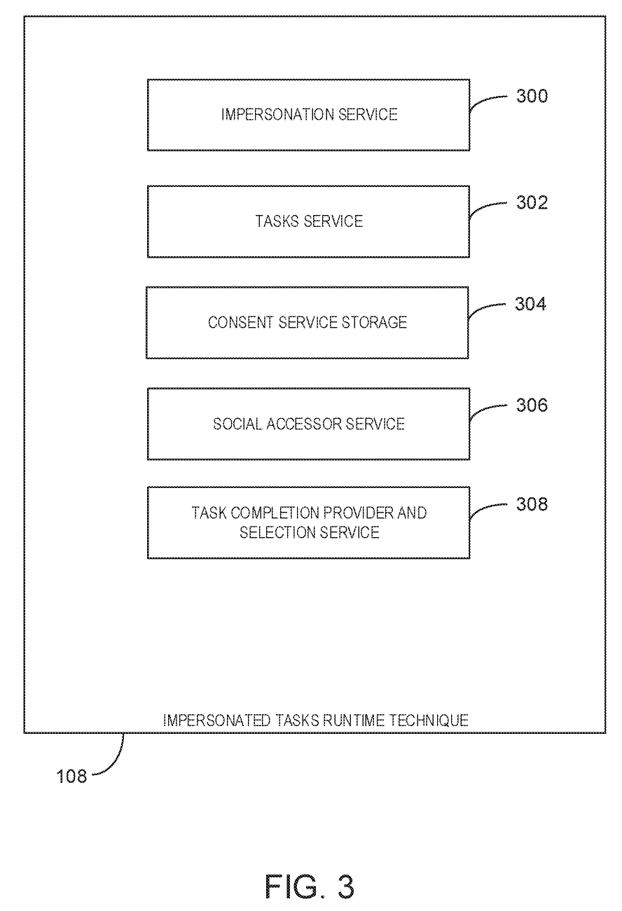

FIG. 3 is a schematic of an example impersonated tasks runtime technique 108. Like numbered items are as described with respect to FIG. 1.

The impersonated tasks runtime technique (ITRT) 108 can include a number of services and modules for managing and creating and distributing tasks among a number of users and user storage techniques. The impersonation service 300 may create an impersonated task based on the manipulations of one user and provide that impersonated task to a number of users with the task service 302. In an example, the task service may send out tasks such as reminders and to dos. The ITRT (108) may also include a consent service storage 304 which stores and consolidates the permissions associated with each task. The consent service storage 304 may process and store permissions gathered from users and may provide the permissions to a task triggering technique. The ITRT 108 ma include a social accessor service 306 to allow access to social media platforms to potentially either pull or push task notifications to ensure that tasks and events between platforms are synchronized. The ITRT 108 may include the task completion provider and selection service 308 to provide and receive updates regarding the completion status of a task to a UPLDTST 104. The ITRT 108 may include a provider selection and handover module that may communicate with for third party delegation and facilitate the handover of user data to a third party where useful.

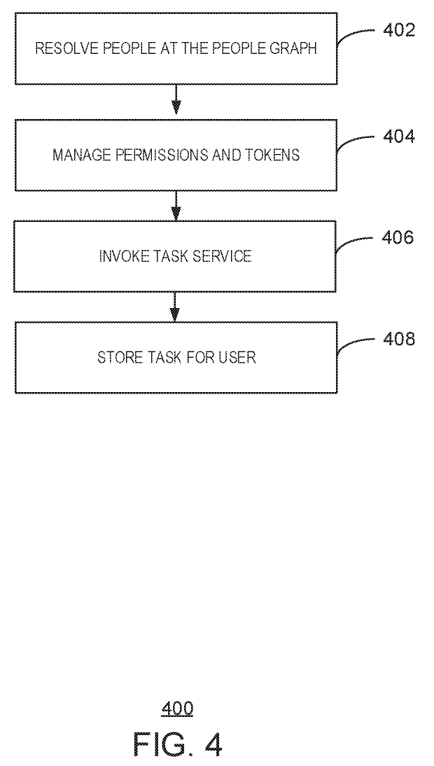

FIG. 4 is a process flow diagram of an example process 400 for managing impersonated tasks in a runtime technique. The elements of the method shown here are presented in an example order, and other orders of this method can also function. The method 400 can be implemented with any suitable computing device, such as the user device 102, the user preference learning a data tasks storage technique 104 and the impersonated tasks runtime technique 108 of FIG. 1.

At block 402, in response to a user creating an impersonated task, a service tries to resolve people to form a people graph. As discussed above with respect to FIG. 1, the people graph may be formed from phone contacts, app contacts, users permitted access to the shared device, and the like.

At block 404, tokens and permissions can be managed once a user has been resolved and identified from the people graph. In response to that resolution and identification, the impersonation service calls a consent service storage to create permissions on the task resource. As discussed above, the consent service storage may manage permissions for the impersonated tasks. In an example, the obtained permissions can be used to fetch the authentication token of a second from a social accessor service or other token holding service. The tokens and permissions may be stored in a consent service storage on a shared device. As used herein, the term permission refers whether or not the target user has given permissions for tasks to be assigned by an input-user or any user creating tasks from the shared device. The consent service storage indicates which users have consented to notification, delegation, status, notification, between users. Within the consent service storage, the disclosure notes that social accessor service is a service which provides the token if the consent service storage indicates there are permissions. The social accessor service provides a token that allows access to a user data store such as a PDP.

At block 406, the impersonation service calls the corresponding tasks service to store the tasks in the corresponding store of users. In an example, the tasks service may include reminders of tasks or a compiled to do list of tasks to provide to a user. At block 408, the task service stores the task in the user data store of corresponding user. Identifying the correct user include a determination of if a task is a shared task or a delegated task. As discussed above, shared tasks may go to an entire group of users and delegated tasks are assigned to a specific user.

As used herein, delegated tasks may be delegated to one person or to a group of people. When delegating to a group of people, typically the delegator would know all of the users and have permissions, however in some examples, the delegation may be based on a locality group, such as a number of people and devices local to a Wi-Fi network or local to a shared device region. Similarly, a delegated task may be to a group that all indicated interest in a particular event thereby giving permissions for task assignment by a delegator. In another example, a delegated task can be delegated to group account rather than to multiple user accounts. Group tasks can be shared tasks which refers to a task where even though a group of people share the task, the task can be marked complete if any member of the group completes it. Conversely, a group task may be delegated in a way where each member must complete the task. Further, another type of group task can include a number of subset tasks so that the subtasks may be distributed among the individual members of the group to each complete their subtask of the larger group task. In an example, the delegation to a group may identify a lead group member to manage the delegation of the subtasks of a larger group task.

The data store that stores user tasks for the user also stores the inferences learned from multiple user signals from user's devices, wherein the signals can include browsing, search engine, apps usage, cloud storage usage, location stream.

The method further includes calling, via an impersonation service, a consent service storage where the call to the consent service storages creates permissions associated with a task resource. The method further includes storing, via a task service, the task in a particular user data store based on if the task is shared or delegated to a particular user. The user data store may also store inference data that is obtained through processing of multiple user signals from user's devices. The user signals that may be stored and processed to obtain an inference includes browsing, search engine, apps usage, cloud storage usage, and location streams. In the described method, the stored tasks may be triggered for one or more users in response to a task triggering technique communicates with the consent service storage about permissions on a particular task resource. As disclosed in the example method, the impersonated tasks that are stored with a particular user or group of users may also be handed over to the third-party providers for completion of task.

In an example, the tasks may be triggered for one or more users at the right time depending on whether it was a delegated task or shared task. The task triggering is taken care of by the task triggering technique that talks to consent service storage for knowing the permissions on the task resource. These tasks can be handed over to the third-party providers for completion of task.

The disclosed techniques provide a technique to the user for creating impersonated tasks where tasks can be created by one person for other using personal assistant. For the personal assistant to let users create impersonated tasks is to first build the understanding of people graph.

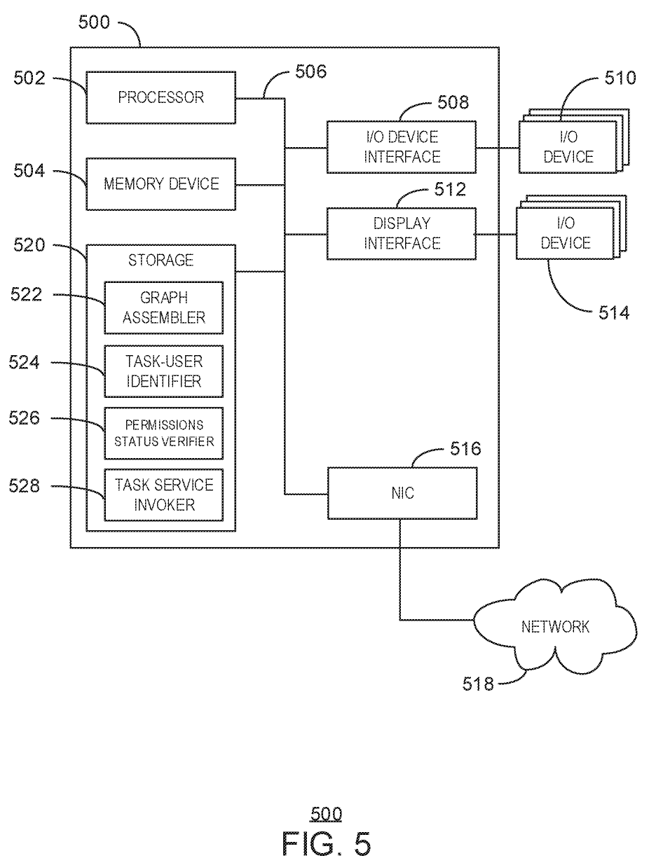

As discussed above, the method may be executed on a hardware system such as the shared device seen in 118 seen in FIG. 1 or the system 500 of FIG. 5. These systems may include the above discussed method and may also perform additional or different steps also related to impersonated task management. For example, a system may include instructions that when executed on a processor may identify, in response to an input-user input, a user generated impersonated task (UGIT) and a task-user from a people graph. The input-user may be a user providing input to a shared device in order to create a task and assign it to another user or multiple users found in the people graph of the shared device. In an example, the users that are able to be contacted or assigned tasks via the shared device may change based on the identity of the input-user. The identity of the input-user may be determined via a login sequence at the shared device.

In another example, the system may include instructions that when executed on a processor may send the UGIT to a data store for a task-user device in response to a verified communication permission status. As mentioned, the consent service storage may host information related to input-user specific permissions to send, assign, and delegate tasks to other users who access the shared device. A system executing the method or variants of the above discussed method may then monitor for an indicator from the task-user device, wherein the indicator corresponds to the completion of the task. While the indicator may indicate a completion status showing that the task is completed, other completion status levels could also be identified such as percentage completions, estimated time of completions, specific sub-steps within the full task assigned, and the like.

The system may execute a method where the system can modify a data object corresponding to the UGIT based on a received indicator from the task-user device to reflect a completion status and a set of users related to the UGIT to be notified of the completion status. After modifying the UGIT, the system can then transmit a digital notification the set of users based on the modified UGIT. The set of users may exclude the user who completed the task and triggered the completion status notification as this user would already know of the completion status of the task. The set of users that are notified may be limited to a single user, such as the input-user, or more specifically, the device of the input user.

In an example, the system executing the above method and its variations may include a verification sequence, screen, or process for the input-user to confirm that the task-user has granted the ability for the input-user to assign tasks to the task-user. The permissions check may be conducted through a search of a consent service storage stored locally within the physical shared device hardware. In an example, if the permissions check reveals that the input-user does not currently have permission to assign a task to a specific task-user, then the shared device may send a notification of a task assignment request to the task-user device. This task assignment request may include an access request notification to the data store of the task-user in response to an unverified communication permission status.

The method being executed by the system may also include correspondence of the shared device with more than one user device. For example, the shared device may be managing the tasks assigned to a user device, where the user device is a first user device. The UGIT may also be assigned and transmitted to a second user device associated with a second user. In this example, the system may be executing a method where the indicator from the first user device indicates the second user device should be notified of a completion status performed. In this example, the transmission of the digital notification may be sent to the second user device based on the modified UGIT.

FIG. 5 is a block diagram of an example of a computing system for handling impersonated tasks. The computing system 500 may be, for example, a mobile phone, laptop computer, desktop computer, or tablet computer, among others. The computing system 500 may include a processor 502 that is adapted to execute stored instructions, as well as a memory device 504 that stores instructions that are executable by the processor 502. The processor 502 can be a single core processor, a multi-core processor, a computing cluster, or any number of other configurations. The memory device 504 can include random access memory (e.g., SRAM, DRAM, zero capacitor RAM, SONOS, eDRAM, EDO RAM, DDR RAM, RRAM, PRAM, etc.), read only memory (e.g., Mask ROM, PROM, EPROM, EEPROM, etc.), flash memory, or any other suitable memory systems.

The processor 502 may be connected through a system bus 506 (e.g., PCI, ISA, PCI-Express, NuBus, etc.) to an input/output (I/O) device interface 508 adapted to connect the computing system 500 to one or more I/O devices 510. The I/O devices 510 may include, for example, a keyboard, a gesture recognition input device, a voice recognition device, and a pointing device, wherein the pointing device may include a touchpad or a touchscreen, among others. The I/O devices 510 may be built-in components of the computing system 500, or may be devices that are externally connected to the computing system 500.

The processor 502 may also be linked through the system bus 506 to a display device interface 512 adapted to connect the computing system 500 to a display device 514. The display device 514 may include a display screen that is a built-in component of the computing system 500. The display device 514 may also include a computer monitor, television, or projector, among others, that is externally connected to the computing system 500. A network interface card (NIC) 516 may also be adapted to connect the computing system 500 through the system bus 506 to a network 518.

The storage 520 can include a hard drive, an optical drive, a USB flash drive, an array of drives, cloud storage, network area storage, or any other suitable storing means or combinations thereof. The storage 518 may include a graph assembler 522, a task-user identifier 524, a permissions status verifier 526, and a task service invoker 528.

The graph assembler 522 can assemble a people graph that includes structuring data from a collection of identities and communication permissions. The people graph is stored in a consent service storage which may be located on the shared device and in the storage 520. In an example, the data structure of identities and communications permissions are assembled from at least one of phone contacts connected to the shared device, application contacts for applications executed on the shared device, and users authenticated on the shared device. The shared device may include an audio output speaker mounted on the shared device and communicatively connected to the processor.

The task-user identifier 524 can identify a task-user in response to a user generated impersonated task (UGIT), where the identification of the task-user includes finding the task-user from the people graph. In an example, the UGIT is created in a device physically separate from the system for impersonated tasks. The UGIT may also have more than one task-user.

The permissions status verifier 526 can attempt to verify a communication permission status between a user who generated the UGIT and the task-user from the consent service storage. The verification process may return an unsuccessful result and the computer-readable storage media has instructions stored to handle an unsuccessful verification attempt.

The task service invoker 528 can pass the UGIT to a data store of the task-user in response to a verified communication permission status. Alternatively, in an example, the invocation by the task service invoker 528 can be to pass an access request notification to the data store of the task-user in response to an unverified communication permission status. In an example, a single task trigger is sent by a task service to a data store for multiple users identified in information of the task, where the task includes permissions allowing any of the multiple users to mark the task complete. The storage 520 may also include instructions that when executed on the processor 502 send a notification of task completion to a user device of the user who created the UGIT, where the response is sent upon receipt of input from the task-user that the task is completed. The shared device, such as the computing system 500, may also include a user interface such as the I/O device interface 508, with inputs for task creation, task sharing, and task delegation by a user. In an example, the user interface is a microphone recording human speech, a digital touch display, or an augmented reality display with motion tracking for input through user movement in relation to objects displayed by the augmented reality display.

It is to be understood that the block diagram of FIG. 5 is not intended to indicate that the computing system 500 is to include all the components shown in FIG. 5. Rather, the computing system 500 can include fewer or additional components not illustrated in FIG. 5 (e.g., additional applications, additional modules, additional memory devices, additional network interfaces, etc.).

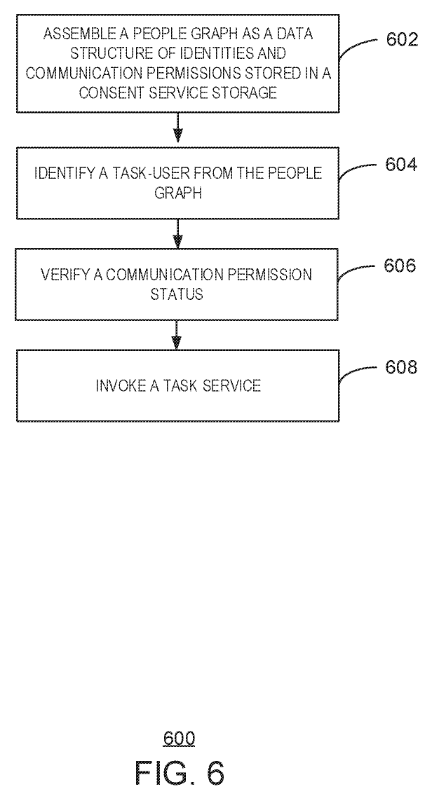

FIG. 6 is a process flow diagram of an example process for implementing impersonated tasks. The elements of the method shown here are presented in an example order, however, other orders of this method can also function. The method 600 can be implemented with any suitable computing device, such as the computing system 500 of FIG. 5.

At block 602, the method 600 includes assembling a people graph as a data structure of identities and communication permissions. The people graph is stored in a consent service storage which may be located on the shared device. In an example, the data structure of identities and communications permissions are assembled from at least one of phone contacts connected to the shared device, application contacts for applications executed on the shared device, and users authenticated on the shared device. The shared device may include an audio output speaker mounted on the shared device and communicatively connected to the processor.

At block 604, the method 600 includes identifying, in response to a user generated impersonated task (UGIT), a task-user from the people graph. In an example, the UGIT is created in a device physically separate from the system for impersonated tasks. The UGIT may also have more than one task-user. At block 606, the method 600 includes verifying a communication permission status between a user who generated the UGIT and the task-user from the consent service storage.

At block 608, the method 600 includes invoking a task service. In an example, the invocation can be to pass the UGIT to a data store of the task-user in response to a verified communication permission status. In an example, the invocation can be to pass an access request notification to the data store of the task-user in response to an unverified communication permission status. In an example, a single task trigger is sent by a task service to a data store for multiple users identified in information of the task, where the task includes permissions allowing any of the multiple users to mark the task complete.

In an example, the method 600 may also include sending a notification of task completion to a user device of the user who created the UGIT, where the response is sent upon receipt of input from the task-user that the task is completed. The shared device may also include a user interface with inputs for task creation, task sharing, and task delegation by a user. In an example, the user interface is a microphone recording human speech, a digital touch display, or an augmented reality display with motion tracking for input through user movement in relation to objects displayed by the augmented reality display.

In one embodiment, the process flow diagram of FIG. 6 is intended to indicate that the steps of the method 600 are to be executed in a particular order. Alternatively, in other embodiments, the steps of the method 600 can be executed in any suitable order and any suitable number of the steps of the method 600 can be included.

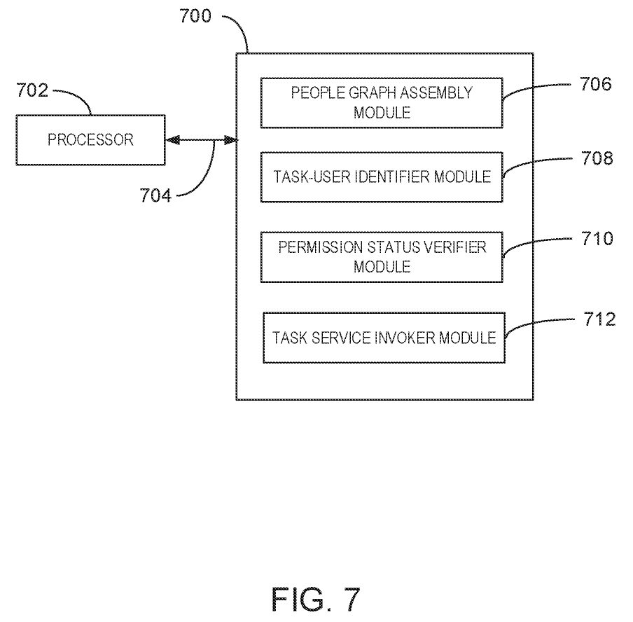

FIG. 7 is block diagram of an example computer-readable storage device for impersonated tasks. The various software components discussed herein may be stored on the tangible, computer-readable storage media 700, as indicated in FIG. 7. The tangible, computer-readable storage media 700 may be accessed by a processor 702 over a computer bus 704. Furthermore, the tangible, computer-readable storage media 700 may include code to direct the processor 702 to perform the steps of the current method 600.

The various software components discussed herein may be stored on the tangible, computer-readable storage media 700, as indicated in FIG. 4. For example, the tangible computer-readable storage media 700 can include a people graph assembly module 706. Assembling a people graph includes structuring data from a collection of identities and communication permissions. The people graph is stored in a consent service storage which may be located on the shared device. In an example, the data structure of identities and communications permissions are assembled from at least one of phone contacts connected to the shared device, application contacts for applications executed on the shared device, and users authenticated on the shared device. The shared device may include an audio output speaker mounted on the shared device and communicatively connected to the processor.

The tangible computer-readable storage media 700 can include a task-user identifier module 708. Identifying a task-user, in response to a user generated impersonated task (UGIT), includes finding the task-user from the people graph. In an example, the UGIT is created in a device physically separate from the system for impersonated tasks. The UGIT may also have more than one task-user.

The tangible computer-readable storage media 700 can include a permission status verifier module 710. Verifying a communication permission status may be between a user who generated the UGIT and the task-user from the consent service storage. For the computer-readable media 700 to function, the verification may return an unsuccessful result and the computer-readable storage media has instructions stored to handle an unsuccessful verification attempt.

The tangible computer-readable storage media 700 can include a task service invoker module 712. The invocation of the task service may include passing the UGIT to a data store of the task-user in response to a verified communication permission status. In an example, the invocation can be to pass an access request notification to the data store of the task-user in response to an unverified communication permission status. In an example, a single task trigger is sent by a task service to a data store for multiple users identified in information of the task, where the task includes permissions allowing any of the multiple users to mark the task complete. The tangible computer-readable media 700 may also include instructions that when executed on a processor send a notification of task completion to a user device of the user who created the UGIT, where the response is sent upon receipt of input from the task-user that the task is completed. The shared device may also include a user interface with inputs for task creation, task sharing, and task delegation by a user. In an example, the user interface is a microphone recording human speech, a digital touch display, or an augmented reality display with motion tracking for input through user movement in relation to objects displayed by the augmented reality display.

It is to be understood that any number of additional software components not shown in FIG. 7 may be included within the tangible, computer-readable storage media 700, depending on the specific application. Although the subject matter has been described in language specific to structural features and/or methods, it is to be understood that the subject matter defined in the appended claims is not necessarily limited to the specific structural features or methods described above. Rather, the specific structural features and methods described above are disclosed as example forms of implementing the claims.

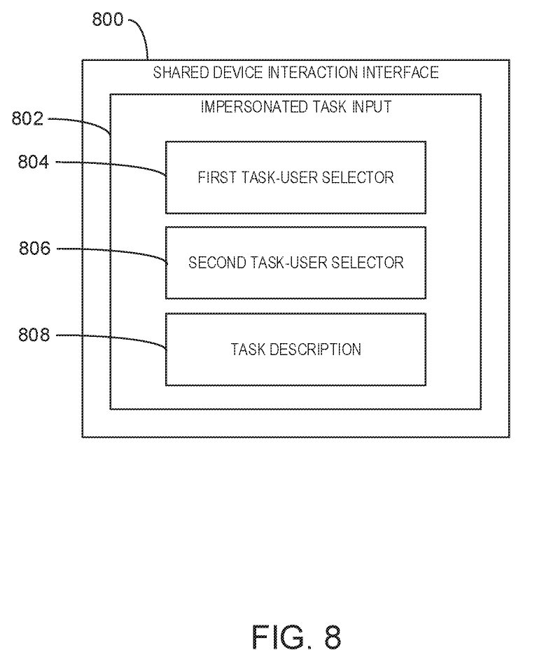

FIG. 8 is block diagram of an example shared device interaction interface 800 for impersonated tasks. The shared device interaction interface 800 can be a touch screen for a user to input and generate impersonated tasks. The shared device interaction interface 800 may also be an audio channel where a user may speak their commands for impersonated task creation. While the interaction interface 800 may be described taking a certain type of input, interaction can also be text based, QWERTY based, graphic user interface (GUI) based through mouse clicks or touch input, as well as facial recognition, or voice controlled and authenticated.

Within the shared device interaction interface 800 an impersonated task input 802 may be the specific region of a touch screen where an input from a user may be received for task creation. In the example of an audio channel, there may be a region where sound input from a user is received most effectively, for example in the case of directional microphones being used in a device.

The impersonated task input 802 includes a first task-user selector 804 and a second task-user selector 806. For the first task-user selector 804 a list of potential users may be presented on a display, where the first-task user may have a task assigned or delegated to them. The first-task user may be chosen from a list provided to the display from the people graph, as discussed above. The first-task user may be manually input or spoken input if their name is known. The first task-user selector 804 may be an area on a touch screen or a first requested input from an audio channel. Similarly, the second task-user input 806 may include an area on a touch screen or second requested input from an audio channel. The second task-user input 806 may allow selection of a second task-user name from a list or may allow manual or spoken entry.

The task description 808 may be a region of space on an impersonated task input 802 area where additional information about the impersonated task may be input to the share device. The task description may include selection of options regarding which user may complete the task, the task title, details of the task such as due date, how many users may be recommended for ease of task completion, when a task is triggered to start, end, and any checkpoints a task may include. Many other options and display regions may be presented on the shared device interaction interface 800 including status updates of previously entered tasks, a login sequence or screen for a user to enter tasks.

The shared device interaction interface 800 may be one way a system such as the system 500 in FIG. 5 executes the above disclosed techniques. For example, the shared device interaction interface 800 may graphically present, via a digital display, an identified task-user and the impersonated, where the task-user is selected from a people graph. Prior to invoking a task service or passing the UGIT to another device, the system may verify a communication permission status between a user who generated the UGIT and the task-user from the consent service storage. In response to a verified communication permission status identified at a consent service storage, the system may pass the UGIT to a data store of the task-user. The shared device interaction interface 800 can then graphically present, via a display, an impersonated task status indicated by the UGIT where the impersonated task status comprises a task-user name and a task completion marker.

In another example involving the shared device interaction interface 800, a digital display may include an interactive area that, in response to a selection action by a user, displays an option to toggle between a disabled and an enablable capability for task creation for impersonated tasks. Similarly, the display may show or present a developer mode of the shared device, where the developer mode may expose editable permissions and identity information from the consent service storage or other data stores discussed above.

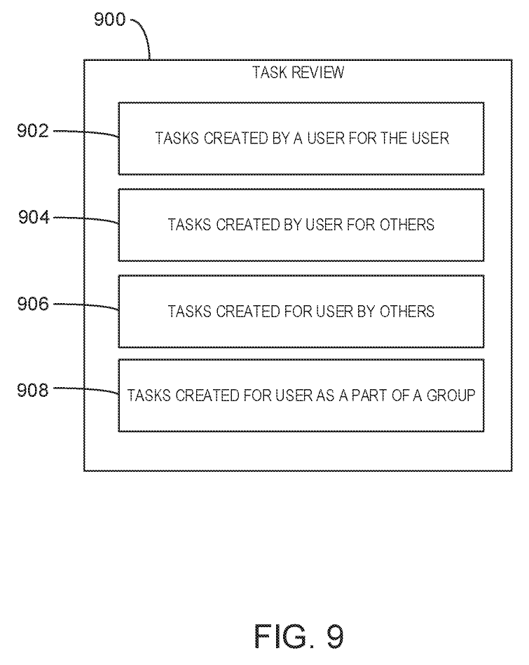

FIG. 9 is block diagram of an example schematic representing a collection of tasks in a collection for task review 900. The collection for task review 900 may be displayed on a screen of a phone, tablet, desktop, laptop, AR system, VR system, television. The collection for task review 900 may also be provided to the user through audio channels such as speakers, headphones, while receiving input through touch, voice commands, eye movements, gestures, and the like.

The task review 900 may display, show, or provide tasks created for a user where those tasks were created by the user for the same user 902. In an example, a user may wish to use a shared device to store a reminder for the same user. The user may verbally state the reminder and when it should be delivered. Alternatively, the task may require completion and request a completion indication by the user in addition to the initial reminder. As a note, these reminders and requests for status updates of any kind may be sent in the form of social media messages, direct to a user device message, text messages, emails, or other message formats suitable to the hardware being used.

The task review 900 may also include tasks created by the user for others 904. The user may create tasks for others that the user wishes to monitor or be made aware of. The display or announcing of these tasks may be separated from the tasks that were created by the user for the user 902 or intermingled based on other criteria such as task creation time or task due date. Depending on if the tasks are displayed on a screen, there may also be an indication associated with the tasks created by the user and assigned to others 904 that indicates a status as either started, completed, or yet to be started.

The task review 900 may also include and display, project, or emit sounds for tasks created for the users by others 906. These tasks may have been assigned by others directly to the user. In an example, the assignment of a task may include a delegation of a task, where the delegation of the task involves a situation where tasks may be assigned in a one-directional manner due to an organization chart, hierarchy, or established relationship between the user and the person creating and assigning the task to the user. As above, the display or announcing of these tasks for the user from others 906 may be separated from other groups of tasks or individual tasks of the task review 900, although these tasks may all be intermingled based on other criteria such as task creation time or task due date.

The task review 900 may also include tasks created for the user as a part of a group 908. As discussed above, the tasks may be created for a group in a number of different ways. A group task may be created for a user and other users to each complete individually, thus saving the task creator the chore of re-inputting the same task over and over. A group task may be created for a user and other users where any one of the users completing the task would result in the task being completed for all of the users in the group. The group task may also refer to a task that has a number of different sub-tasks or parts to be completed or delegated to various members of a group. As above, the display or announcing of these tasks for the user as part of a group 908 may be separated from other groups of tasks or individual tasks of the task review 900, although these tasks may all be intermingled based on other criteria such as task creation time or task due date.

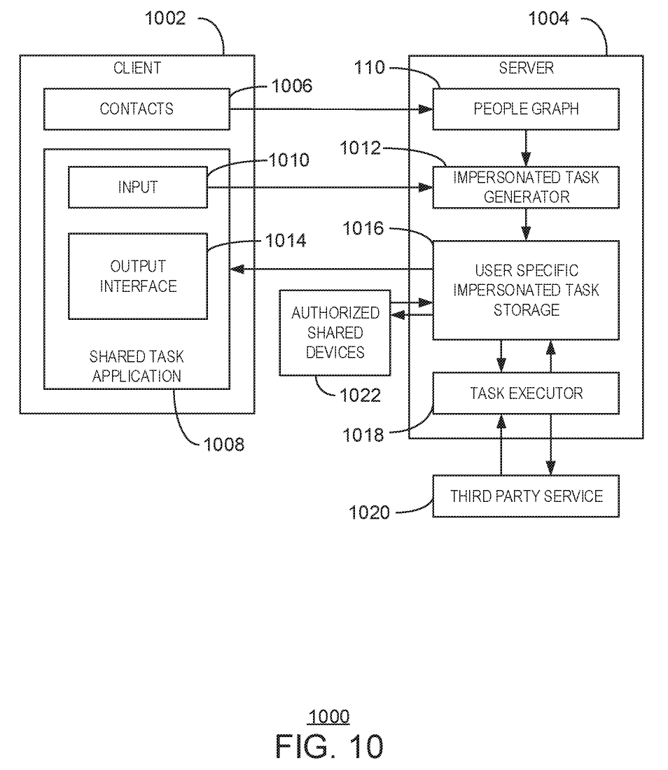

FIG. 10 is block diagram of an example client-server system architecture 1000 for impersonated tasks and a shared device to operate within. The arrows shown do not impose a strict order of execution, but instead represent a general flow of information. For example, although an arrow directs information flow from a first item to a second item, this does not limit the initiation or exchange of data to a push or pull from or to either item.

The client-server system architecture 1000 can include a client 1002 and a server 1004. As discussed above, the specific embodiments are provided as one example of actual implementation in hardware and other platforms and systems may also be used. Similarly, the specific modules and operational elements may be stored on a client 1002 or a server 1004. In an example, the shared device may be the client 1002 and a cloud server may be the server 1004. More local servers such as on-site-computers may also be used as the server 1004. Further, the client 1002 may be a laptop, a wearable computing device, a tablet, a desktop computer, a mobile phone, a mobile smartphone, an augmented reality (AR) system, a virtual reality (VR) system and the like.

Referring to the specific techniques discussed above, the people graph 110 may be stored locally on a device of the client 1002 or may be stored in a device of the server 1004. Depending on the device, inputs by a user are received at the client 1002. Similarly, outputs are also generated and displayed, projected, or emitted by the client 1002. Other operations discussed in the tasks and steps above may be processed at either the client 1002 or the server 1004 interchangeably. For example, the creation of the task object in software can be done through instructions located on the client 1002 prior to storage or transmission. Alternatively, instructions to create a task object may be sent from a client 1002 to the server 1004 where the creation and storage of the task may be remotely handled. Similar ability to locally or remotely create and manage impersonated tasks is contemplated.

FIG. 10 shows how contacts 1006 may be stored in a client 1002. As discussed above, these contacts 1006 maybe saved names and phone numbers associated with a friend, business associate, or family member stored local to the client 1002. The contacts 1006 may include an identification number, location, or picture associated with an individual user. The contacts 1006 may represent that a relationship exists between a user and another individual. The contacts 1006 may be extracted from social media accounts, email accounts, imported from a spreadsheet, or manually input. The contacts 1006 may be sent to the server 1004 in order for a people graph 110 to be formed as described above. While the contacts 1006 are shown coming from the client 1002, other sources of contacts 1006 may exist including contacts 1006 drawn from a second client device or another server.

Separately from the formation of the people graph 110, the client 1002 may make use of a shared task application 1008 to receive input 1010 related to tasks. The input may be user generated or generated by automated services, artificial intelligence services, digital assistants from the client 1002 or other devices. As discussed above, the input 1010 can be voice input, touch input, typed input, mouse and pointer input, or input derived from eye-tracking or augmented and virtual reality systems. The input may include information about an impersonated task that a user may wish to create, update or delete. This input may be passed to the server 1004 to the impersonated task generator 1012. The impersonated task generator receives the input 1010 and forms an impersonated task. The impersonated task may be as described above. The impersonated task can be a file, a table of information, a group of nodes containing task information, or a data object.

As discussed above, impersonated tasks are directed to a user or task user by the user providing input 1010. Accordingly, the impersonated task generator 1012 not only formalizes the input into an impersonated task, but also imparts permissions information into the impersonated task from information in the people graph 110. As discussed in more detail above, the permissions a user prefers for certain relationships may be determined from information the user has provided relating preferences of the user in the people graph. Based on if a user has a permission to generate an impersonated task for a task user, the impersonated task generator 1012 may include a token indicating this permission in the impersonated task that is generated.

Once an impersonated task has been generated with any appropriate tokens and permissions, the impersonated task may be useful when output on an output interface 1014 of the client 1002. For the client 1002 to be able to access and output the impersonated event, the shared task application 1008 accesses the task from a user specific impersonated task storage 1016. The access of the user specific impersonated task storage 1016 by the shared task application may be through commands of a digital assistant or by manual user selection via input 1010. The user specific impersonated task storage 1016 is user specific as each user of a shared device may have different tasks assigned to them and assigned by them. For example, in a family situation, a parent may have a different user specific impersonated task storage 1016 than a child so that when a parent asks for tasks assigned to the parent, the tasks assigned to the parent may be returned and output. Similarly, if a child were to request their tasks, the tasks stored in the user specific impersonated task storage 1016 of the child would return the tasks of the child.

The server 1004 may also include a task executor 1018. As discussed above, the tasks may be executed by a machine or third party if designated to do so by the user creating the impersonated task. In some cases the server 1004 itself may be able to complete a task by making use of data from the people graph 110. The arrows from the task executor 1018 back to the user specific impersonated task storage 1016 relate to status updates based on the completion of tasks either locally or through other machines, devices, or services. The task executor 1018 may manage status updates as a task completes without the user. For example, if the task is a task to be completed by a user, then the task executor 1018 would not monitor a task completion rate or status. However, if the task executor is passing information to a third party service 1020 for execution, then the task executor may also receive updates of task completion and pass status updates back to the user specific impersonated task storage 1016. As discussed above, the task executor in the server 1004 may request third party services 1020 such as ride sharing apps, weather services, online shopping venues, online search engines, payment transfer applications or other third party services to take action based on an impersonated task a user has requested. Upon completion, the third party may return a status of completion to the task executor 1018 and any additional data that may be needed for further task execution or display in the output interface 1014 of the client 1002.

The user specific impersonated task storage may also communicated with authorized shared devices 1022. These devices may be other shared devices, other server environments, or other machines authorized to obtain information from the server 1004. Through the use communication of authorized shared devices 1022, developers may access the functionality of impersonated tasks, impersonated task execution, and output to a client device. In another example, authorized devices may also add to or modify the people graph as well as the method of impersonated task generation.

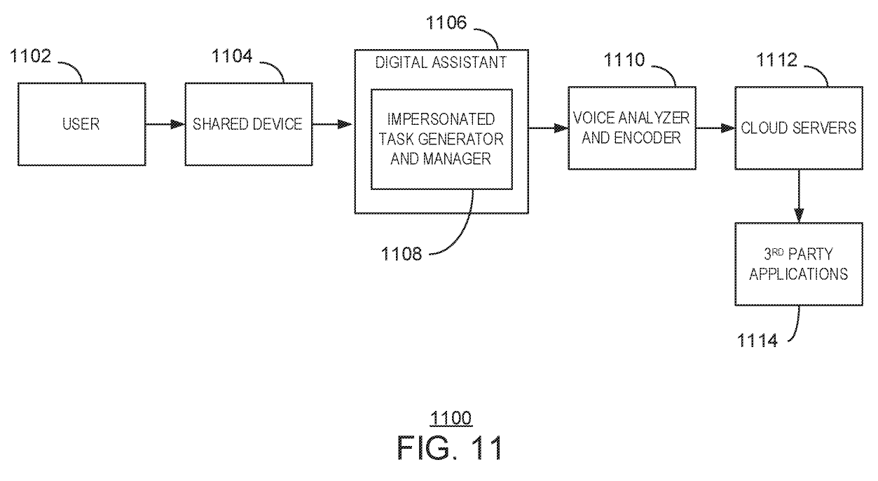

FIG. 11 is block diagram of an example schematic representing a framework 1100 for vocally received impersonated tasks. The arrows shown do not impose a strict order of execution, but instead represent a general flow of information. For example, although an arrow directs information flow from a first item to a second item, this does not limit the initiation or exchange of data to a push or pull from or to either item.

A user 1102 may be speaking to a shared device 1104. As discussed above, the shared device 1104 may use spoken word as input. The shared device can include a microphone for receiving spoken input by a user, a speaker to return output to a user, a storage, a processor, and networking hardware to communicate with the internet. The shared device 1104 may process input from a user 1102 by passing the input to a digital assistant 1106. FIG. 11 shows a digital assistant separately from the shared device 1104 to show that a digital assistant 1106 may be remotely operating and executing away from the physical location and hardware of the shared device 1104. This is one example, and other embodiments are contemplated including a digital assistant with instructions and execution of instructions for the digital assistant occurring inside the hardware and physical coverings encasing the shared device 1104.

The digital assistant 1106 may process the input from the user 1102. In an example, an impersonated task generator and manager 1108 may be part of the digital assistant processing. A digital assistant 1106 may contain rudimentary voice recognition software in order to determine if an impersonated task is being requested by the user 1102. As described above, when input from a user 1102 indicates the need to create an impersonated task, a digital assistant may generate the task through the use of an impersonated task generator and manager 1108.

The digital assistant 1106 may also make use of a voice analyzer and encoder 1110. In certain cases speech may not be understood by a default digital assistant due to a regional dialect, regional services, products, company names, locations, or due to idiomatic expressions. In such instances, the digital assistant may request further analysis of user input through a specialized voice analyzer and encoder 1110. The voice analyzer and encoder 1110 may be an add-on module local to a specific geographic region or context. If any details from the user input are further uncovered through the vocal analysis, then the voice analyzer and encoder 1110 may encode that additional information into the impersonated task through the digital assistant 1106.

The fully encoded impersonated task may then be located and stored in a cloud server 1112. From the cloud server 1112, an impersonated task may be retrieved or returned to the shared device 1104 for output to a user 1102. Further, the cloud server 1112 may invoke the services of 3^{rd} party applications 1114 in order to complete the goals of a task. In an example, the impersonated tasks may be embedded with a token or other access code for a 3^{rd} party application based on permissions of a user 1102. The ability of an impersonated task to be completed by a 3^{rd} party application can include access to a 3^{rd} party application API, purchasing through an API, control of a home through the 3^{rd} party service, and other functions undertaken by third party services that may interact with shared devices and digital assistants.

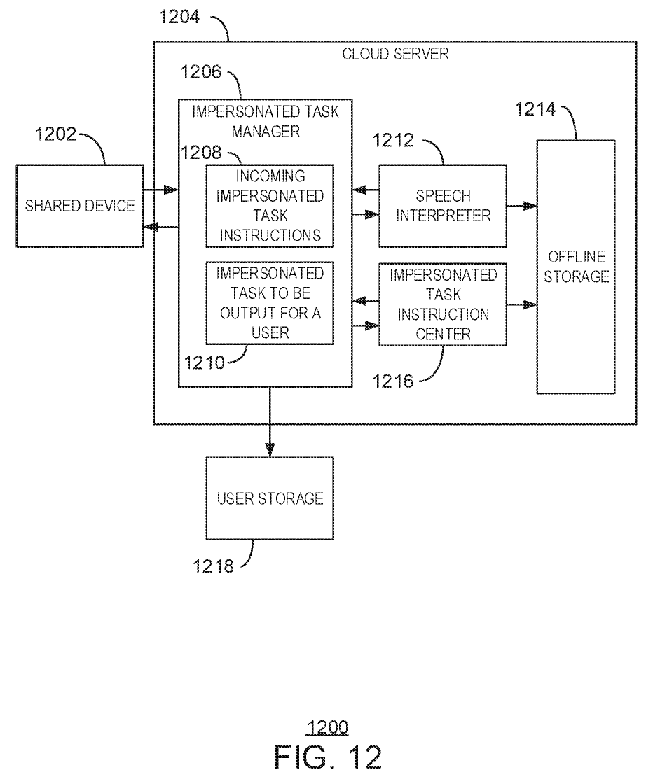

FIG. 12 is block diagram of an example schematic representing a digital assistant management system 1200. The arrows shown do not impose a strict order of execution, but instead represent a general flow of information. For example, although an arrow directs information flow from a first item to a second item, this does not limit the initiation or exchange of data to a push or pull from or to either item.

A shared device 1202 interacting with a digital assistant management system 1200 may send and receive data to nodes of a cloud server 1204. In an example, a cloud server 1204 may include an impersonated task manager 1206. The impersonated task manager 1206 may include processing power and networking capabilities. For example, an impersonated task manager 1206 may receive and store incoming impersonated task instructions 1208. The impersonated task manager 1206 may also store and then transmit impersonated tasks to be output for a user 1210 as discussed in more detail above.

In generating the impersonated tasks, the impersonated task manager 1206 may communicate with a speech interpreter 1212 to translate and encode user input speech for storage either temporarily with the impersonated task manager 1206 or longer term in offline storage 1214 for a shared device 1202 in case of data shortages, bandwidth reductions, and the like. The impersonated task manager 1206 may further transmit and receive feedback data from an impersonated task instruction center 1216.

This impersonated task instruction center 1216 may search within all stored tasks in both the impersonate task manager and offline storage to determine the dates these tasks may be due for completion. Upon determination of a task nearing a deadline, the impersonated task instruction center 1216 may pass a task to an impersonated task manager 1206 with an alert indicating that a task completion deadline is approaching. The impersonated task manager may transmit the impersonated task to a shared device for output and alerting of a user. In addition, an impersonated task manager 1206 may communicate data to a user storage 1218 separate from a shared device 1202. The user storage 1218 may include a user phone, smartphone device, flash storage, tablet, smartwatch, AR system, VR system, wearable devices and other personal devices.

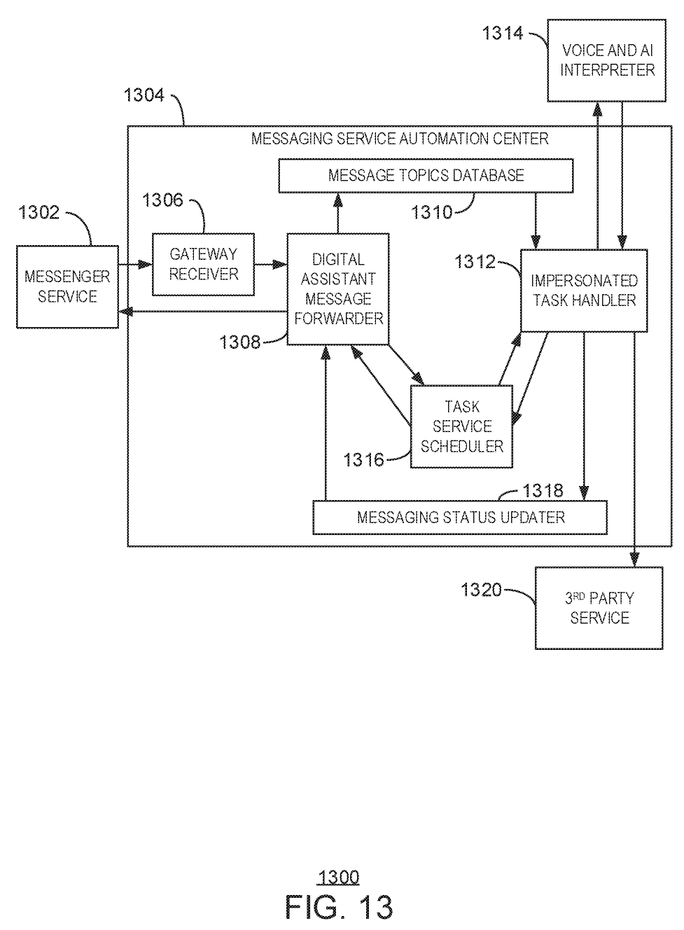

FIG. 13 is block diagram of an example schematic representing an integration of user-based scheduled messages and impersonated tasks 1300. The arrows shown do not impose a strict order of execution, but instead represent a general flow of information. For example, although an arrow directs information flow from a first item to a second item, this does not limit the initiation or exchange of data to a push or pull from or to either item.

A messenger service 1302 may include a digital or electronic based means for a user to create and send messages. This can include web-based chat software, social media specific messaging services, text messaging, electronic mail, and the like. A messenger service 1302 may communication with a messaging service automation center 1304 in order to automate requests made in the messages received by the messenger service 1302. A gateway receiver 1306 may receive a message in a messaging service automation center 1304 from a messenger service 1302. The gateway receiver may then pass the message to a digital assistant message forwarder 1308.

The digital assistant message forwarder 1308 may be interacting with a digital assistant located on a shared device or cloud service or local to the messaging service automation center 1304. A digital assistant may aid a digital assistant message forwarded by identifying key features about the message including a general topic of the message, any instructions that may be within the message, potential users identified in the message. The message may be forwarded based on instructions from a digital assistant. The message may be forwarded by the digital assistant message forwarder 1308 to a message topics database 1310 based on a topic identified in the message. In an example the topic of a message may have been identified by a digital assistant. Similarly, a message may include an instruction to update, create, remove, or complete an impersonated task from one user to another, from a user to themselves, or any other similar combination.

Once a message has been passed to a message topics database 1310 based on a topic identified in the message, the message may be handled by an impersonated task handler 1312. When a message has been determined to include an impersonated task, the impersonate task handler 1312 may complete the tasks or pass the task to an appropriate service. In an example, the impersonated task found in the message may not be clearly known at the time an impersonated task is received as the impersonated task handler 1312. When the subject matter of an impersonated task needs further interpretation, the impersonated task handler 1312 may pass the data and any user vocal input to a voice and artificial intelligence interpreter 1314 located remotely from the messaging service automation center 1314. FIG. 13 shows the voice and Al interpreter as remote to the messaging service automation center 1304 but other configurations are possible including a co-location of these two items. The impersonated task handler 1312 may also communicate with a task service scheduler 1316. Based on the due dates, urgency, or priority of various tasks for a user, a task scheduler service may identify a next task for completion to the digital assistant message forwarder and/or the impersonated task handler 1312. The impersonate task handler 1312 may send updates of a completion status of a task to the messaging status updater 1318 which in turn may update the digital assistant message forwarder 1308. By updating the digital assistant message forwarder 1308, a digital assistant may be alerted to a status update even if the update would not affect the scheduling of the task by the task service scheduler 1316. The update of the task status may be communicated from the digital assistant message forwarder 1308 to the messenger service 1302. The messenger service may in turn communicate with the user through a shared device or a personal device based on the platform of the messenger service 1302 and the preferences of the user. As discussed above, to complete a task, the impersonated task handler 1312 may pass impersonated tasks to a 3^{rd} party service for completion or other actions as dictated by the impersonated task, the message, and the API of the 3^{rd} party service.

As utilized herein, terms “component,” “system,” “client” and the like are intended to refer to a computer-related entity, either hardware, software (e.g., in execution), and/or firmware, or a combination thereof. For example, a component can be a process running on a processor, an object, an executable, a program, a function, a library, a subroutine, and/or a computer or a combination of software and hardware. By way of illustration, an application running on a server and the server can be a component. One or more components can reside within a process and a component can be localized on one computer and/or distributed between two or more computers.

Furthermore, the claimed subject matter may be implemented as a method, apparatus, or article of manufacture using programming and/or engineering techniques to produce software, firmware, hardware, or any combination thereof to control a computer to implement the disclosed subject matter.

Computer-readable storage devices or media can include and are not limited to magnetic storage devices (e.g., hard disk, floppy disk, and magnetic strips, among others), optical disks (e.g., compact disk (CD), and digital versatile disk (DVD), among others), smart cards, and flash memory devices (e.g., card, stick, and key drive, among others). Computer-readable storage media does not include all implementations of computer-readable media generally, such as signals per se. Therefore, in contrast, computer-readable media generally (i.e., not computer-readable storage media) may additionally include communication media such as transmission media for wireless signals and the like.

In particular and in regard to the various functions performed by the above described components, devices, circuits, systems and the like, the terms (including a reference to a “means”) used to describe such components are intended to correspond, unless otherwise indicated, to any component which performs the specified function of the described component, e.g., a functional equivalent, even though not structurally equivalent to the disclosed structure, which performs the function in the herein illustrated exemplary aspects of the claimed subject matter. In this regard, it will also be recognized that the innovation includes a system as well as a computer-readable storage media having computer-executable instructions for performing the acts and events of the various methods of the claimed subject matter.

There are multiple ways of implementing the claimed subject matter, e.g., an appropriate API, tool kit, driver code, operating system, control, standalone or downloadable software object, etc., which enables applications and services to use the techniques described herein. The claimed subject matter contemplates the use from the standpoint of an API (or other software object), as well as from a software or hardware object that operates according to the techniques set forth herein. Thus, various implementations of the claimed subject matter described herein may have aspects that are wholly in hardware, partly in hardware and partly in software, as well as in software.

The aforementioned systems have been described with respect to interoperation between several components. It can be appreciated that such systems and components can include those components or specified sub-components, some of the specified components or sub-components, and additional components, and according to various permutations and combinations of the foregoing. Subcomponents can also be implemented as components communicatively coupled to other components rather than included within parent components (hierarchical).

Additionally, it can be noted that one or more components may be combined into a single component providing aggregate functionality or divided into several separate sub-components, and any one or more middle layers, such as a management layer, may be provided to communicatively couple to such subcomponents in order to provide integrated functionality. Any components described herein may also interact with one or more other components not specifically described herein but generally known by those of skill in the art.

In addition, while a particular feature of the claimed subject matter may have been disclosed with respect to one of several implementations, such feature may be combined with one or more other features of the other implementations as may be desired and advantageous for any given or particular application. To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

### EXAMPLES

### Example 1

This specification generally discloses a system for dynamically managing impersonated tasks through a shared device including a processor and a storage with instructions that can be executed on the processor. The system can include identify, in response to input from an input-user, a user generated impersonated task (UGIT) and a task-user from a people graph. The system can include send the UGIT to a data store for a task-user device in response to a verified communication permission status. The system can include monitor for an indicator from the task-user device, where the indicator corresponds to completion of the UGIT. The system can include modify a data object corresponding to the UGIT based on the indicator from the task-user device to reflect a completion status and a set of users related to the UGIT to be notified of the completion status. The system can include transmit a digital notification to the set of users based on the modified UGIT.

The system where the verified communication permission status is based on a workplace organizational hierarchy that includes the roles and permissions of the input-user and the task-user, where a the input-user with a managerial role is able to delegate to a task-user, and where an input-user that is not a manager of the task-user is not able to delegate a task to the task-user. The system where the verified communication permission status is based on a familial relationship between the task-user and the input user where the higher status of an older generation in a family structure allows an input-user of an older generation to delegate tasks to a task-user in response to a determination that the task-user is in a younger generation. The system may also be implemented such that a task-user device is a first user device and the processor transmits the UGIT to a second user device associated with a second user. In this system, the indicator from the first user device indicates the second user device is to be notified of a completion status performed. In this system the processor sends a transmission of the digital notification to the second user device based on the modified UGIT. The system comprising an audio output speaker mounted on the shared device and communicatively connected to the processor. The system where a single task trigger is sent by a task service to the data store for multiple users identified in information of the UGIT, where the UGIT includes permissions allowing any of the multiple users to mark the UGIT complete. The system may also be implemented such that an interaction model is responsive to inputs for UGIT creation, UGIT sharing, and task delegation by the user. The system includes the interaction model is responsive to input received at a microphone recording human speech. The system where the interaction model is responsive to inputs from a detected user movement relative to objects displayed by an augmented reality display. The system where the storage includes instructions that, in response to execution by the processor, cause the processor to verify a communication permission status between the input-user and the task-user from a consent service storage. The system where the storage includes instructions that, in response to execution by the processor, cause the processor to pass, with a task service, an access request notification to the data store of the task-user in response to an unverified communication permission status. The method comprising presenting, with the display, an interactive area that, in response to a selection action by the user, displays an option to toggle between a disabled and an enabled capability for task creation for the UGIT. The method comprising presenting a developer mode of the shared device, the developer mode to expose editable permissions and identity information from the consent service storage. The method comprising invoking the task service to pass an access request notification to the data store of the task-user in response to an unverified communication permission status. The method comprising sending a notification of task completion to a user device of the user who created the UGIT, where the notification is sent upon receipt of input from the task-user that the UGIT is completed. The method comprising an audio output speaker mounted on the shared device and communicatively connected to a processor. The method where a single task trigger is sent by the task service to the data store for multiple users identified in information of the task, where the task includes permissions allowing any of the multiple users to mark the task complete. The method comprising a user interface comprising inputs for UGIT creation, UGIT sharing, and UGIT delegation by a user. The computer-readable storage device where the UGIT is created in a device physically separate from a shared device for impersonated tasks.

### Example 2

This specification generally discloses a method for managing impersonated tasks, including creating a user generate impersonated task (UGIT) based on an input received through an interaction model of a shared device. The method also includes graphically presenting, via a display, an identified task-user and the UGIT, where the task-user is selected from a people graph. The method also includes verifying a communication permission status between a user who generated the UGIT and the task-user from a consent service storage. The method also includes invoking a task service to pass the UGIT to a data store of the task-user in response to a verified communication permission status identified at the consent service storage. The method also includes graphically presenting, via the display, an impersonated task status indicated by the UGIT where the impersonated task status includes a task-user name and a task completion marker.

The method comprising presenting, with the display, an interactive area that, in response to a selection action by the user, displays an option to toggle between a disabled and an enabled capability for task creation for the UGIT. The method comprising presenting a developer mode of the shared device, the developer mode to expose editable permissions and identity information from the consent service storage. The method comprising invoking the task service to pass an access request notification to the data store of the task-user in response to an unverified communication permission status. The method comprising sending a notification of task completion to a user device of the user who created the UGIT, where the notification is sent upon receipt of input from the task-user that the UGIT is completed. The method comprising an audio output speaker mounted on the shared device and communicatively connected to a processor. The method where a single task trigger is sent by the task service to the data store for multiple users identified in information of the task, where the task includes permissions allowing any of the multiple users to mark the task complete. The method comprising a user interface comprising inputs for UGIT creation, UGIT sharing, and UGIT delegation by a user. The computer-readable storage device where the UGIT is created in a device physically separate from a shared device for impersonated tasks.

### Example 3

This specification generally discloses a computer-readable storage device that stores instructions that may be executed by a processor. The instructions may be executed to identify, in response to an input-user input, a user generated impersonated task (UGIT) and a task-user from a people graph. The instructions of the computer-readable storage device may be executed to send the UGIT to a data store for a task-user device in response to a verified communication permission status. The instructions of the computer-readable storage device may be executed to monitor for an indicator from the task-user device, where the indicator corresponds to completion of the task. The instructions of the computer-readable storage device may be executed to modify the UGIT based on a received indicator from the task-user device to reflect a completion status and a set of users related to the UGIT to be notified of the completion status. The instructions of the computer-readable storage device may be executed to transmit a digital notification the set of users based on the modified UGIT. The computer-readable storage device where the UGIT is created in a device physically separate from a shared device for impersonated tasks.

What is claimed is:

1. A system for dynamically managing impersonated tasks through a shared device comprising:
a processor;
a storage with instructions that, in response to execution by the processor, cause the processor to:
identify, in response to input from an input-user, a user generated impersonated task (UGIT) and a task-user from a people graph;
send the UGIT to a data store for a task-user device in response to a verified communication permission status;
monitor for an indicator from the task-user device, wherein the indicator corresponds to completion of the UGIT;
modify a data object corresponding to the UGIT based on the indicator from the task-user device to reflect a completion status and a set of users related to the UGIT to be notified of the completion status; and
transmit a digital notification to the set of users based on the modified UGIT.

2. The system of claim 1, wherein the verified communication permission status is based on a workplace organizational hierarchy that comprises the roles and permissions of the input-user and the task-user, wherein a the input-user with a managerial role is able to delegate to a task-user, and where an input-user that is not a manager of the task-user is not able to delegate a task to the task-user.

3. The system of claim 1, wherein the verified communication permission status is based on a familial relationship between the task-user and the input user where the higher status of an older generation in a family structure allows an input-user of an older generation to delegate tasks to a task-user in response to a determination that the task-user is in a younger generation.

4. The system of claim 1, wherein:
the task-user device is a first user device;
the processor transmits the UGIT to a second user device associated with a second user;
the indicator from the first user device indicates the second user device is to be notified of a completion status performed; and
the processor sends a transmission of the digital notification to the second user device based on the modified UGIT.

5. The system of claim 1, comprising an audio output speaker mounted on the shared device and communicatively connected to the processor.

6. The system of claim 1, wherein a single task trigger is sent by a task service to the data store for multiple users identified in information of the UGIT, where the UGIT comprises permissions allowing any of the multiple users to mark the UGIT complete.

7. The system of claim 1, wherein:
an interaction model is responsive to inputs for UGIT creation, UGIT sharing, and task delegation by the user, and
the interaction model is responsive to input received at a microphone recording human speech.

8. The system of claim 1, wherein the storage comprises instructions that, in response to execution by the processor, cause the processor to verify a communication permission status between the input-user and the task-user from a consent service storage.

9. The system of claim 1, wherein the storage comprises instructions that, in response to execution by the processor, cause the processor to pass, with a task service, an access request notification to the data store of the task-user in response to an unverified communication permission status.

10. The system of claim 7, wherein the interaction model is responsive to inputs from a detected user movement relative to objects displayed where the objects displayed are grouped by the user who generated the task and the type of task created.

11. A method for managing impersonated tasks, comprising:
creating a user generate impersonated task (UGIT) based on an input received through an interaction model of a shared device;
graphically presenting, via a display, an identified task-user and the UGIT, where the task-user is selected from a people graph;
verifying a communication permission status between a user who generated the UGIT and the task-user from a consent service storage;
invoking a task service to pass the UGIT to a data store of the task-user in response to a verified communication permission status identified at the consent service storage; and
graphically presenting, via the display, an impersonated task status indicated by the UGIT where the impersonated task status comprises a task-user name and a task completion marker.

12. The method of claim 11, comprising presenting, with the display, an interactive area that, in response to a selection action by the user, displays an option to toggle between a disabled and an enabled capability for task creation for the UGIT.

13. The method of claim 11, comprising presenting a developer mode of the shared device, the developer mode to expose editable permissions and identity information from the consent service storage.

14. The method of claim 11, comprising invoking the task service to pass an access request notification to the data store of the task-user in response to an unverified communication permission status.

15. The method of claim 11, comprising sending a notification of task completion to a user device of the user who created the UGIT, where the notification is sent upon receipt of input from the task-user that the UGIT is completed.

16. The method of claim 11, comprising an audio output speaker mounted on the shared device and communicatively connected to a processor.

17. The method of claim 11, wherein a single task trigger is sent by the task service to the data store for multiple users identified in information of the task, where the task includes permissions allowing any of the multiple users to mark the task complete.

18. The method of claim 11, comprising a user interface comprising inputs for UGIT creation, UGIT sharing, and UGIT delegation by a user.

19. A computer-readable storage device that stores instructions that, in response to an execution by a processor, cause the processor to:
identify, in response to an input-user input, a user generated impersonated task (UGIT) and a task-user from a people graph;
send the UGIT to a data store for a task-user device in response to a verified communication permission status;
monitor for an indicator from the task-user device, wherein the indicator corresponds to completion of the task;
modify the UGIT based on a received indicator from the task-user device to reflect a completion status and a set of users related to the UGIT to be notified of the completion status; and
transmit a digital notification the set of users based on the modified UGIT.

20. The computer-readable storage device of claim 19, wherein the UGIT is created in a device physically separate from a shared device for impersonated tasks.
